(19) United States
(12) Patent Application Publication
(10) Pub. No.: US 2011/0114525 A1
(43) Pub. Date: May 19, 2011

(54) NOVEL REUSABLE APPARATUS FOR AFFIXING GIFT MATERIAL TO A PRESENTATION DEVICE

(76) Inventor: Donald Hoffman, Oceanside, CA (US)

(21) Appl. No.: 12/846,610

(22) Filed: Jul. 29, 2010

Related U.S. Application Data
(60) Provisional application No. 61/261,713, filed on Nov. 16, 2009.

(51) Int. Cl. B65D 85/00; B23P 19/04; F16B 2/20

(52) U.S. Cl. 206/457; 29/700; 411/511; 411/512

(57) ABSTRACT

A novel, reusable apparatus for affixing gift material to a presentation device. The apparatus comprises a dynamic fastener for clasping or holding a gift material, allowing for the transportation, packaging, and delivery of the combination of the apparatus and the gift material. The fastener uses one or more prongs to exert force upon the gift material towards the vertical axis of the fastener, thereby retaining said gift material. The fastener is connected to the presentation device in order to create an overall arrangement that is pleasing to the many senses of the user and recipient. Embodiments leverage known materials, themes and branding to enhance or achieve a commercial objective.

This application claims priority to U.S. Provisional Patent Application No. 61/261,713 filed Nov. 16, 2009, the entirety of which is incorporated by reference, as if fully set forth herein, including all Paris Convention priority rights.

### BACKGROUND

1. Field

This disclosure relates to gift packaging and management tools.

2. General Background

The present disclosure is directed to gift packaging and management tools. Specially, the present disclosure is directed to an apparatus designed for clasping material to a presentation device in order to enhance a user's overall sensory perception of at least one of the material, the apparatus, and/or a collateral branding theme. For many years, the gift and novelty industry has provided consumers with options for affixing visually-appealing objects to gift material. Cards, live flowers, and wrapping paper are among the most common embodiments of such options. However, most gift delivery mechanisms such as wrappings and containers have at least partially, if not entirely, enveloped and covered the gift material enclosed therein. Most gift delivery mechanisms have been relegated to such covering apparatuses due to (1) ease in manufacturing, (2) user acceptance, (3) universal fitting of gift material, and (4) inability to reuse the gift delivery mechanism.

It is also important to note that promotional items are often gifted, in whole or in part, to potential customers or existing customers. Yet another desideration is fulfilled by aspect of the instant teaching being used to these ends, as explained below and claimed herein.

Notably, the attachment of gift material to an un-containerized or external presentation device has been hampered by the lack of a universal clasping or fitting apparatus able to secure heterogeneously-shaped and -sized gift material to said presentation devices. Common solutions to this dilemma include stapling, gluing, and taping. However, these solutions are each plagued by limitations in their dexterity, aestheticism, and reusability. That is, prior to the advent of the instant teaching.

It is desirable to have an apparatus for clasping or otherwise attaching one or more gift materials to a delivery device when the delivery device improves the aestheticism and user approval of the combination of said delivery device and gift material. The combination of the delivery device and gift material may illicit a heightened response from the recipient if the delivery device visually, comically, or otherwise enhances their joint presentation, especially when the gift material is wholly or partially revealed. The most desirable attributes of such a delivery device include its appealing aesthetics, compatibility with different shapes and sizes of gift materials, reusability, ease and cost of manufacture, and transportability.

### SUMMARY

Briefly stated, a novel, reusable apparatus for affixing gift material to a presentation device. The apparatus comprises a dynamic fastener for clasping or holding a gift material, allowing for the transportation, packaging, and delivery of the combination of the apparatus and the gift material. The fastener uses one or more prongs to exert force upon the gift material towards the vertical axis of the fastener, thereby retaining said gift material. The fastener is connected to the presentation device in order to create an overall arrangement that is pleasing to the many senses of the user and recipient. Embodiments leverage known materials, themes and branding to enhance or achieve a commercial objective. Green, or sustainable aspect of the instant teachings facilitate efforts to conserve.

### DRAWINGS

The above-mentioned features and objects of the present disclosure will become more apparent with reference to the following description taken in conjunction with the accompanying drawings wherein like reference numerals denote like elements and in which:

FIG. 1 is a schematic depiction of apparatus according to the present invention.

### DETAILED DESCRIPTION

The present invention contributes to the progress of science and the useful arts by enabling those who usually give flowers to receive a substantially identical kind of gift and appreciate it. The fastener is designed to be one-piece, constructed out of one of any metals, plastics, rubbers, composites, and biodegradable substances. The fastener is generally reusable and interchangeable among various presentation device attachments.

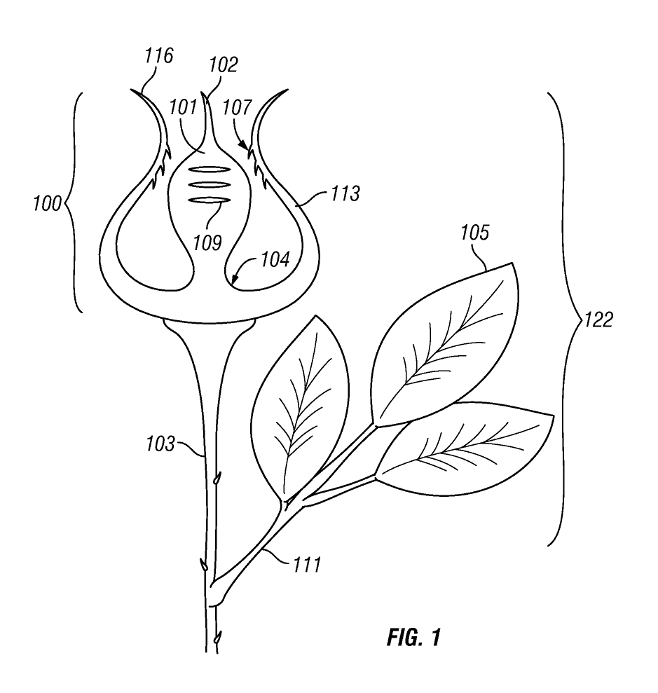

Referring to FIG. 1, fastener 100 is at least one of unitary and modular and further includes at least one prong 102. Fastener 100 is metal/plastic/rubber, may be coated, painted, processed/stamped, molded, bent or twisted; likewise, additional prongs 113, 116 often are helpful in securing target material (not shown-see Appendix for Examples, e.g. mini-liquor bottles)

Retaining surface 104 is located on the inside of prong 102 (and each of additional prongs 113/116) and presentation-device 103 may be in the shape of a branch, and/or be a branch, stem or other aspect of a flower/plant natural or artificial. Supplemental extension 111, appear to be a branchette (sub branch), or leaf sporting branch in this example.

Those skilled in the art understand that inherent in any prong 102/113/116 etc . . . , is a concave section protruding toward central axis of fastener 100. Also, gripping or detent means 107, 109 allow for bracingly engaging any desired material. Ventral surface 101 of prong 102 (and prongs 113/116 etc . . . ) may sport colors, paint, logos, advertising or whatever else is needed to make the article visually compelling.

Presentation device 103 attaches as known to artisans by adhesion, adherence, molding or other glue-mechanisms, or by clamping. The schematic example here may be hybridized with real or artificial flower-elements and prototypes have housed material (not shown) ranging from small bottles of liquor (see appendix) to motorcycle parts, assorted items that may or may not relate to the theme, or branding scheme of the subject apparatus 122. Articles embodying these descriptions are available from at least one source (See the Manflower® from Creative Concepts of Oceanside, Calif. 92056).

The fastener may contain one or more prongs 102/113/116. The prongs are aligned towards one of the two ends of the base of the fastener. Said prongs 102/113/116, in their preferred embodiment, are shaped in a curved fashion, having both outwardly convex and inwardly concave slopes, the many prongs creating varied inner diameter as measured from the fastener's central axis. The many prongs are constructed of one of many substances having properties of pliability and resistance suitable for the retention of gift materials to be clasped by said prongs. See Appendix for prototypes, as discussed.

In one embodiment, a series of four prongs are constructed of a continuous sheet of stamped steel, wherein each of the four prongs are curved towards one end of the fastener, shaped in a fashion that both outwardly convex and inwardly concave slopes are present in each of the many prongs, the inner portion of said prongs creating a varied inner diameter as measured from the fastener's central axis, wherein the smallest inner diameter is present at approximately the middle of the fastener's vertical axis, and wherein the inward slopes of the many prongs above this smallest inner diameter point, act to apply an increasing amount of resistance towards the central axis when a cylindrical gift material is inserted into the fastener's inner diameter along the centrals axis. Said resistance will reach a maximum force of any given diameter of the inserted gift material when the many prong's curve defined as the smallest inner diameter is activated. At this point of maximum resistance, the inserted gift material will be generally affixed to the fastener, allowing for the packaging, transportation, and delivery of the combination fastener, gift material, and presentation device. Upon its receipt, or at any other time, a user may apply a pressure upon the gift material while the fastener is stationary, along the general vertical axis of the fastener, in a direction towards the formerly open diameter end of the fastener, in order to overcome the maximum resistance of the many prong, thereby separating the gift material from the fastener.

In another embodiment, the fastener has only one prong. Said prong is an uninterrupted cylinder from the portion of the prong's base to approximately two thirds of the prong's length, at which point the cylinder shape of the prong is interrupted by ornamental or functional design features, the smallest inner diameter of said prong occurring before the cylinder is interrupted by said features, and the challis-shaped end of the prong and base is capable of retaining various liquids in addition to retaining materials having a cylindrical or other profile fitting within the opening diameter of the open end of the fastener.

In a further embodiment, the inner retaining surface of each or one prong that comes into contact with the inserted material at or near the smallest inner diameter of the fastener has one or more protrusions jutting into the general direction central axis of the fastener. Said protrusions may be convex moldings of the same or different substance as the fastener or its respective prong(s). In one embodiment, said protrusions are rubber nodules affixed to the inner retaining surface of one or more prongs. Said rubber nodules act as a further contacting surface and especially assist with the retention of glass, plastic, or composite materials, especially glass containers of beer and wine bottles.

In yet a further embodiment, the fastener is capable of being attached to a presentation device, by means of one of many methods including male and female threads, Velcro, glue, epoxy, clamping, molding, soldering, welding, and snap fittings, wherein the presentation device is shaped and decorated as a stem and leaf or leaves of a rose or other flower, and the fastener is shaped and decorated as a flower or the many petals of a rose or other flower.

While the method and agent have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. A device for attaching a gift comprising:
a base comprising a first and a second end;
a prong attached at said first end of base, wherein said prong is shaped like a leaf and extends outwardly;
a rod attached at said second end of base, wherein said rod is shaped like a stem and extends down a central axis'
said gift to be held in place by said prong against said first end of base.

2. The device, according to claim 1, wherein said prong is further comprised of a gripper.

3. The device, according to claim 2, wherein said gripper is constructed of rubber.

4. The device, according to claim 2, wherein said gripper is constructed of a plastic coating.

5. The device, according to claim 1, wherein said prong is spring-loaded.

6. The device, according to claim 1, wherein a flower petal is attached to said rod and extends outwardly from central axis.

7. The device, according to claim 1, wherein said base and said prong is constructed of a continuous sheet of stamped steel.

8. The device, according to claim 1, wherein said prong is attached to said base by means of a male and female thread.

9. The device, according to claim 1, wherein said prong is attached to said base by means of snap fittings.

10. A method of attaching a gift to a device, which comprises, in combination:
providing a base having a first end and a second end;
providing a rod coupled to the second end of base extended outwardly along a central axis;
providing at least one prong shaped like a flower petal and attached to the first end of base;
securing the gift with the prong by clamping the gift to the first end of base.

11. The method of claim 10, whereby the gift delivered is a liquor bottle.

12. The method of claim 10, whereby the gift delivered is a motorcycle part.

13. A fastener adapted to attach a gift material to the fastener comprising:
a fastener having two ends and a central axis;
at least one prong at one end of said fastener, said prong extending outwardly from one end of said fastener;
a retaining surface of at least one prong, said retaining surface including at least one projection able to physically contact said gift material, and said projection able to exert physical contact with said gift material sufficient to retain said gift material and the fastener together, said projection including a sloped surface on the inner facing portion of said prong, said sloped surface extending from a first position to a second position, said second position being spaced closer to the central axis of said fastener than said first position.

14. The fastener, according to claim 13, wherein said fastener is unitary.

15. The fastener, according to claims 13, wherein said fastener is modular.

16. The fastener, according to claim 14, wherein one end of the fastener is generally closed; and said end retains various liquids input by a user.

17. The fastener, according to claim 14 wherein said fastener is constructed of a metal substance.

18. The fastener, according to claim 14 wherein said fastener is constructed of a plastic substance.

19. The fastener, according to claim 14 wherein said fastener is constructed of a rubber substance.

20. The fastener, according to claim 14 wherein said fastener is constructed of a composite substance.
